(19) United States
(12) Patent Application Publication
(10) Pub. No.: US 2026/0133822 A1
(43) Pub. Date: May 14, 2026

(54) MODEL TRAINING TASK SCHEDULING METHOD AND APPARATUS, AND ELECTRONIC DEVICE

(71) Applicants: DOUYIN VISION CO., LTD., Beijing (CN); Lemon Inc., Grand Cayman (KY)

(72) Inventors: Yuanqiang Liu, Beijing (CN); Yihao Zhao, Beijing (CN); Yanghua Peng, Los Angeles, CA (US); Yibo Zhu, Los Angeles, CA (US)

(21) Appl. No.: 18/873,644

(22) PCT Filed: Aug. 11, 2023
(86) PCT No.: PCT/CN2023/112568

§ 371 Date: Oct. 21, 2025

(30) Foreign Application Priority Data
Aug. 20, 2022 (CN) 202211001696.0

(51) Int. Cl. G06F 9/48; G06F 9/50

(52) U.S. Cl. CPC G06F 9/4881; G06F 9/5038

(57) ABSTRACT

The present disclosure provides a model training task scheduling method and apparatus, and an electronic device. A specific embodiment of the method comprises: determining a target task group, the target task group comprising a plurality of model training tasks to be processed; determining task scheduling information, the task scheduling information comprising a processing sequence of the plurality of model training tasks; and scheduling, based on the task scheduling information, the plurality of model training tasks to use a plurality of model training resources in parallel such that different model training tasks use different model training resources at the same time. This embodiment avoids contention for model training resources between different model training tasks, and improves utilization of the model training resources, and improves efficiency of model training.

### CROSS-REFERENCE TO RELATED APPLICATION

The present disclosure claims the priority from the CN patent application No. 202211001696.0, titled “MODEL TRAINING TASK SCHEDULING METHOD AND APPARATUS, AND ELECTRONIC DEVICE”, filed with the China National Intellectual Property Administration (CNIPA) on Aug. 20, 2022, the content of which is incorporated herein by reference in its entirety.

### FIELD

The present disclosure relates to the field of machine learning technologies, and in particular, to a scheduling method, apparatus and an electronic device for a model training task.

### BACKGROUND

With continuous development of artificial intelligence technologies, deep learning has been widely applied to various fields, and training a deep learning model has become an important task. A variety of resources are required in a model training process. Deep learning models have huge differences in model size and type, and any of the resources may become a bottleneck of the deep learning model training task, resulting in low resource utilization and difficulty in improving training efficiency in the training process of the deep learning model. Currently, a method for effectively improving model training efficiency is needed.

### SUMMARY

The present disclosure provides a scheduling method, apparatus and an electronic device for a model training task.

According to a first aspect, a scheduling method for a model training task is provided. The method comprises:
determining a target task group, the target task group comprising a plurality of model training tasks to be processed;
determining task scheduling information, the task scheduling information comprising a processing sequence of the plurality of model training tasks; and
scheduling, based on the task scheduling information, the plurality of model training tasks to use a plurality of model training resources in parallel such that different model training tasks use different model training resources at the same time.

According to a second aspect, a scheduling apparatus for a model training task is provided. The apparatus comprises:
an obtaining module configured to determine a target task group, the target task group comprising a plurality of model training tasks to be processed;
a determining module configured to determine task scheduling information, the task scheduling information comprising a processing sequence of the plurality of model training tasks; and
a scheduling module configured to schedule, based on the task scheduling information, the plurality of model training tasks to use a plurality of model training resources in parallel such that different model training tasks use different model training resources at the same time.

According to a third aspect, a computer-readable storage medium is provided. The storage medium stores a computer program which, when executed by a processor, cause the process to implement the method according to any of the first aspect.

According to a fourth aspect, an electronic device is provided. The electronic device comprises a memory, a processor, and a computer program that is stored in the memory and can run on the processor. the program, when executed by the processor, cause the processor to implement the method according to any one of the first aspect.

The technical solutions provided in the embodiments of the present disclosure may include the following beneficial effects:
In the scheduling method and apparatus for a model training task provided in the embodiments of the present disclosure, a plurality of model training tasks in a task group are scheduled to a plurality of model training resources of different types for parallel processing, such that different model training tasks use different model training resources at the same time. In this way, contention for model training resources between different model training tasks is avoided, and utilization of the model training resources is improved, and efficiency of model training is improved.

It should be understood that the foregoing general description and the following detailed description are merely example and explanatory, and cannot limit the present disclosure.

### BRIEF DESCRIPTION OF THE DRAWINGS

In order to more clearly describe the technical solutions in the embodiments of this specification, the accompanying drawings for describing the embodiments are briefly described below. Apparently, the accompanying drawings in the following description show merely some embodiments described in this specification, and a person of ordinary skill in the art may still derive other drawings from these accompanying drawings without creative efforts.

FIG. 1 is a schematic diagram of an architecture of a model training system according to an example embodiment of the present disclosure;

FIG. 2 is a flowchart of a scheduling method for a model training task according to an example embodiment of the present disclosure;

FIG. 3A is a flowchart of another scheduling method for a model training task according to an example embodiment of the present disclosure;

FIG. 3B is a schematic diagram of a scheduling scenario for a model training task according to an example embodiment of the present disclosure;

FIG. 3C is a schematic diagram of another scheduling scenario for a model training task according to an example embodiment of the present disclosure;

FIG. 4 is a block diagram of a scheduling apparatus for a model training task according to an example embodiment of the present disclosure;

FIG. 5 is a schematic block diagram of an electronic device according to some embodiments of the present disclosure;

FIG. 6 is a schematic block diagram of another electronic device according to some embodiments of the present disclosure; and

FIG. 7 is a schematic diagram of a storage medium according to some embodiments of the present disclosure.

### DETAILED DESCRIPTION OF EMBODIMENTS

In order that persons skilled in the art better understand the technical solutions in this specification, the technical solutions in the embodiments of this specification are clearly and completely described below with reference to the accompanying drawings in the embodiments of this specification. Apparently, the described embodiments are merely some but not all of the embodiments of this specification. All other embodiments obtained by a person of ordinary skill in the art based on the embodiments of this specification without creative efforts shall fall within the protection scope of this specification.

When the following description refers to the accompanying drawings, the same numbers in different accompanying drawings denote the same or similar elements unless otherwise indicated. The implementation manners described in the following example embodiments do not represent all implementation manners consistent with the present disclosure. Instead, they are merely examples of apparatuses and methods consistent with some aspects of the present disclosure as detailed in the appended claims.

The terms used in the present disclosure are merely for the purpose of describing specific embodiments, and are not intended to limit the present disclosure. The singular forms “a”, “the” and “this” used in the present disclosure are also intended to include the plural forms, unless the context clearly indicates other meanings. It should also be understood that the term “and/or” as used herein refers to and includes any or all possible combinations of one or more associated listed items.

It should be understood that although various information may be described in the present disclosure using the terms first, second, third, etc., these information should not be limited to these terms. These terms are only used to distinguish the same type of information from each other. For example, without departing from the scope of the present disclosure, first information may also be referred to as second information, and similarly, second information may also be referred to as first information. Depending on the context, the word “if” as used herein may be explained as “when” or “while” or “in response to determining”.

With continuous development of artificial intelligence technologies, deep learning has been widely applied to various fields, and training a deep learning model has become an important task. A variety of resources are required in a model training process. For example, in an iteration process of model training, the following stages need to be sequentially completed: reading training data (using a storage resource); preprocessing data and performing a simulation operation in reinforcement learning (using a CPU resource); performing a forward propagation process and a backward propagation process (using a GPU resource); and performing gradient synchronization between work ends in distributed training (using a network resource).

Deep learning models have huge differences in model size and type, and any of the resources may become a bottleneck of the deep learning model training task. Currently, in the related art, a deep learning model training task usually exclusively uses various resources, or only considers sharing of GPU resources. However, when the deep learning model training only uses GPU resources, or the GPU resources are a bottleneck of deep learning training, the resource allocation solution of exclusive resource use or only considering sharing of GPU resources can improve the speed of the deep learning training (that is, the training throughput) to a certain extent. However, if only sharing of GPU resources is considered, different model training tasks use the same GPU resources, which will result in contention for resources and increase resource usage and task completion time, thereby reducing the efficiency of model training.

The scheduling method for a model training task provided in the present disclosure schedules a plurality of model training tasks in a task group to a plurality of model training resources of different types for parallel processing, such that different model training tasks use different model training resources at the same time. In this way, contention for model training resources between different model training tasks is avoided, and utilization of the model training resources is improved, and efficiency of model training is improved.

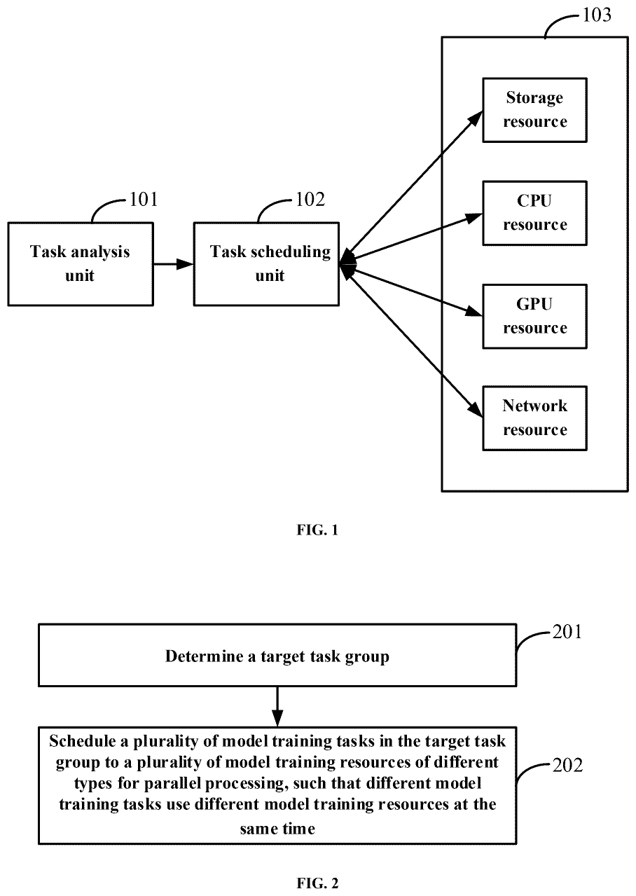

FIG. 1 is a schematic diagram of an architecture of a model training system according to an example embodiment.

As shown in FIG. 1, the model training system may include a task analysis unit 101, a task scheduling unit 102, and a model training resource 103. The model training resource 103 may include, but are not limited to, a storage resource, a CPU resource, a GPU resource, a network resource, and the like. Specifically, first, the task analysis unit 101 obtains a task group including a plurality of model training tasks, and obtains an estimated duration for each model training task in the task group which uses each model training resource. Then, the estimated duration for each model training task in the task group which uses each model training resource and the task group are transmitted to the task scheduling unit 102.

The task scheduling unit 102 may sort the model training tasks in the task group to obtain a plurality of alternative scheduling modes. An optimal target scheduling mode is selected from the alternative scheduling modes based on the estimated duration for each model training task which uses each model training resource. The model training tasks are scheduled to different model training resources in the training resource 103 based on the target scheduling mode.

For example, the task group includes a task A and a task B, and the target scheduling mode indicates that the task A is arranged before the task B. After the model training starts, the task scheduling unit 102 first schedules the task A to a storage resource in the model training resource 103. After the task A uses the storage resource, the model training resource 103 return a result obtained by processing the task A to the task scheduling unit 102. The task scheduling unit 102 then schedules the task A to a CPU resource based on the result, and simultaneously schedules the task B to the storage resource. While the task A uses the CPU resource, the task B uses the storage resource in parallel. After the model training resource 103 return the result obtained by processing the task A and the result obtained by processing the task B to the task scheduling unit 102, the task scheduling unit 102 schedules the task A to a GPU resource in the model training resource 103 based on the result obtained by processing the task A, and schedules the task B to a CPU resource in the model training resource 103 based on the result obtained by processing the task B. Subsequently, while the task A uses the GPU resource, the task B uses the CPU resource in parallel. The subsequent steps are similar, and are not described herein again.

The present disclosure will be described in detail below with reference to specific embodiments.

FIG. 2 is a flowchart of a scheduling method for a model training task according to an example embodiment. An execution subject of the method may be implemented as any device, platform, server, or device cluster with a computing and processing capability. The method may include the following steps.

As shown in FIG. 2, in step 201, a target task group is determined.

In this embodiment, the target task group may be obtained, wherein the target task group includes a plurality of model training tasks to be processed, and the model training tasks may be training tasks involving various deep learning models. For example, the involved model may be a convolutional neural network (CNN), a deep reinforcement learning network (DRN), a deep interest network (DIN), or the like. It may be understood that this embodiment is not limited to a specific type of the models.

In an implementation, a plurality of model training tasks may be randomly obtained from a task pool to form the target task group. In another implementation, the model training tasks in the task pool may be analyzed and combined by using a preset algorithm, so as to obtain the target task group including the plurality of model training tasks. It may be understood that the target task group may also be obtained in any other reasonable manner, and this embodiment is not limited to the specific manner of obtaining the target task group.

In step 202, the plurality of model training tasks in the target task group are scheduled to a plurality of model training resources of different types for parallel processing, such that different model training tasks use different model training resources at the same time.

In this embodiment, the plurality of model training tasks in the target task group may be scheduled to the plurality of model training resources of different types for parallel processing at the same time, such that different model training tasks use different model training resources at the same time. The plurality of model training resources of different types may include, but are not limited to, a storage resource, a CPU resource, a GPU resource, a network resource, and the like. In addition, the number of the model training tasks in the target task group should be less than or equal to the number of the model training resources.

Optionally, in an implementation, the task scheduling information may be determined first, wherein the task scheduling information may include a processing sequence of the plurality of model training tasks in the target task group. The plurality of model training tasks may be scheduled to the plurality of model training resources based on the task scheduling information, such that different model training tasks use different model training resources at the same time.

Specifically, the model training process may be divided into a plurality of training stages, and each training stage schedules each model training task once. At the beginning of each training stage, different model training tasks are scheduled to different model training resources. After the processing results of the model training tasks are all returned, the current training stage is completed, and the next training stage is started. For the same model training resource, the model training tasks use the model training resource in different training stages based on the processing sequence included in the task scheduling information.

For example, the target task group includes a task A, a task B, and a task C, and the model training resources include a resource 1, a resource 2, and a resource 3. A task processing sequence included in the task scheduling information is the task B, the task A, and the task C. At the beginning of the training, first, the task B may be scheduled to the resource 1. After the result B1 obtained by the task B using the resource 1 is returned, the task B is scheduled to the resource 2 based on the result B1, and the task A is scheduled to the resource 1. After the result B2 obtained by the task B using the resource 2 and the result Al obtained by the task A using the resource 1 are both returned, the task B is scheduled to the resource 3 based on the result B2, the task A is scheduled to the resource 2 based on the result A1, and the task C is scheduled to the resource 1. After the result B3 obtained by the task B using the resource 3, the result A2 obtained by the task A using the resource 2, and the result C1 obtained by the task C using the resource 1 are all returned, the task B is scheduled to the resource 1 based on the result B3, the task A is scheduled to the resource 3 based on the result A2, and the task C is scheduled to the resource 2 based on the result C1.

Then, a cyclic iteration process of the training is entered. A process of scheduling a model training task once is equivalent to one training stage. For example, in a training stage a, the task B is scheduled to the resource 1, the task A is scheduled to the resource 3, and the task C is scheduled to the resource 2. After the result B1 obtained by the task B using the resource 1, the result A3 obtained by the task A using the resource 3, and the result C2 obtained by the task C using the resource 2 are all returned, the training stage a ends, and a training stage b is entered. In the training stage b, the task B is scheduled to the resource 2, the task A is scheduled to the resource 1, and the task C is scheduled to the resource 3. The subsequent process is similar, and is not described herein again.

Optionally, the plurality of model training tasks may be scheduled to the plurality of model training resources of different types by using the same process, so as to reduce an extra overhead of model training task scheduling by merging execution environments. Further, optionally, the plurality of model training resources include a GPU resource, and different model training tasks may use the GPU resource through a same context of a compute unified device architecture (CUDA). Because the GPU resource is used in the same CUDA context, an overhead of switching the CUDA context can be eliminated, and execution efficiency is improved.

In the scheduling method for a model training task provided in the present disclosure, a plurality of model training tasks in a task group are scheduled to a plurality of model training resources of different types for parallel processing, such that different model training tasks use different model training resources at the same time. In this way, contention for model training resources between different model training tasks is avoided, and utilization of the model training resources is improved, and efficiency of model training is improved.

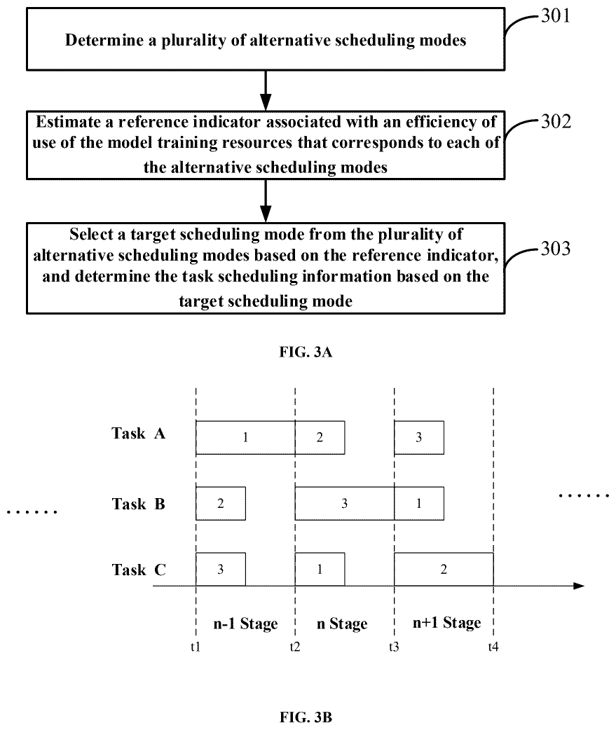

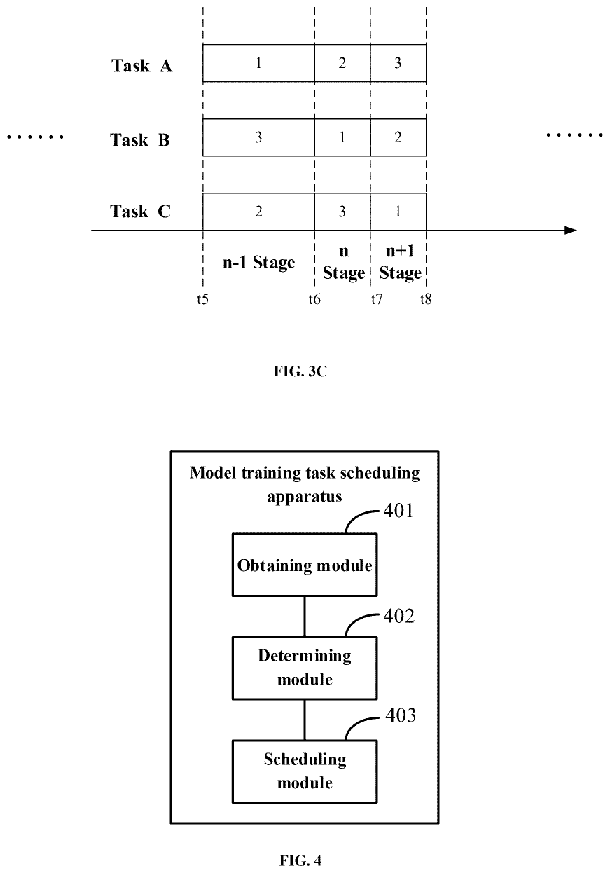

FIG. 3A is a flowchart of another scheduling method for a model training task according to an example embodiment. This embodiment describes a process of determining task scheduling information, and includes the following steps.

As shown in FIG. 3A, in step 301, a plurality of alternative scheduling modes are determined.

In this embodiment, different scheduling modes correspond to different processing sequences of the model training tasks, and the plurality of alternative scheduling modes may be determined by enumeration. For example, the target task group includes a task A, a task B, and a task C, and the model training resources include a resource 1, a resource 2, and a resource 3. Then, a scheduling mode M1 and a scheduling mode M2 may be obtained by in the manner of enumeration, wherein a processing sequence corresponding to the scheduling mode M1 is the task A, the task B, and the task C, and the processing sequence corresponding to the scheduling mode M2 is the task A, the task C, and the task B. It is to be noted that because the training process of the model is a cyclic iteration process, the scheduling mode corresponding to the sequence ABC and the scheduling mode corresponding to the sequence BCA and the sequence CAB are the same.

In step 302, a reference indicator related to the efficiency of use of the model training resources that corresponds to each of the alternative scheduling modes is estimated. In addition, in step 303, a target scheduling mode is selected from the plurality of alternative scheduling modes based on the reference indicator, and the task scheduling information is determined based on the target scheduling mode.

Because the duration for each model training task which uses each model training resource is different, the inventors have found that the efficiency of use of the model training resources also varies greatly in different scheduling modes. As shown in FIG. 3B and FIG. 3C, FIG. 3B and FIG. 3C are schematic diagrams of an iteration process of the model training tasks A, B, and C in two scheduling modes of using the model training resources 1, 2, and 3. The horizontal axis represents time, a length of a rectangle in the horizontal axis direction represents the duration for the model training task which uses the model training resource, and a number in the rectangle represents the model training resource used by the model training task.

As shown in FIG. 3B, in one scheduling mode, after entering a (n−1)th training stage, the task A is scheduled to the resource 1, and the duration for the task A to use the resource 1 is (t2−t1). The task B is scheduled to the resource 2, and the duration for the task B which uses the resource 2 is (t2−t1)/2. The task C is scheduled to the resource 3, and the duration for the task C which uses the resource 3 is also (t2−t1)/2. After the task A, the task B, and the task C are all completed, the nth training stage is entered, the task A is scheduled to the resource 2, and the duration for the task A which uses the resource 2 is (t3−t2)/2. The task B is scheduled to the resource 3, and the duration for the task B which uses the resource 3 is (t3−t2). The task C is scheduled to the resource 1, and the duration for the task C which uses the resource 1 is also (t3−t2)/2, and the subsequent process is similar. After t4, a next iteration process is entered.

As shown in FIG. 3C, in another scheduling mode, after entering the (n−1)th training stage, the task A is scheduled to the resource 1, and the duration for the task A which uses the resource 1 is (t6−t5). The task B is scheduled to the resource 3, and the duration for the task B which uses the resource 3 is also (t6−t5). The task C is scheduled to the resource 2, and the duration for the task C which uses the resource 2 is also (t6−t5). After the task A, the task B, and the task C are all completed, the n-th training stage is entered, the task A is scheduled to the resource 2, and the duration for the task A which uses the resource 2 is (t7−t6)/2. The task B is scheduled to the resource 1, and the duration for the task B which uses the resource 1 is also (t7−t6)/2. The task C is scheduled to the resource 3, and the duration for the task C which uses the resource 3 is also (t7−t6)/2, and the subsequent process is similar. After t8, a next iteration process is entered. Therefore, by comparing FIG. 3B with FIG. 3C, it can be learned that in the scheduling mode shown in FIG. 3C, the utilization of the model training resources is higher.

Therefore, a reference indicator corresponding to each of the alternative scheduling modes can be estimated, wherein the reference indicator is related to the efficiency of use of the model training resources. Then, a scheduling mode with the highest efficiency of use of the model training resources is selected from the alternative scheduling modes based on the reference indicator as a target scheduling mode.

Specifically, first, a first estimated duration for each model training task which uses each model training resource may be obtained. The first estimated duration for each model training task which uses each model training resource may be directly calculated by using a preset algorithm.

Optionally, because when conditions (such as a model type, a hyperparameter, and device configuration) do not change much, the duration for any model training task which uses any model training resource does not change much either. Therefore, the duration for some model training tasks which uses each model training resource under some conditions may be stored in advance. For any model training task, when obtaining the first estimated duration for the model training task which uses any model training resource, the first estimated duration for the model training task which uses the model training resource may be first found from a pre-stored database. If the first estimated duration is not recorded in the pre-stored data, the first estimated duration is obtained through analysis and calculation based on the model training resource and the model training task.

For example, a pre-deployed model performance analysis tool may be used to calculate the first estimated duration for the model training task which uses the model training resource. Optionally, the first estimated duration obtained through the analysis and calculation may be stored in the database such that the first estimated duration for the model training task which uses the model training resource can be directly obtained from the database in the future. In this embodiment, the duration for some model training tasks which uses each model training resource under some conditions is pre-stored in the database, thereby reducing a calculation overhead caused by analyzing and calculating the first estimated duration in the process of obtaining the first estimated duration.

Then, the reference indicator corresponding to each of the alternative scheduling modes may be estimated based on the first estimated duration for each model training task which uses each model training resource. The reference indicator may be various reference indicators related to the efficiency of use of the model training resources. Specifically, a second estimated duration of an iteration process corresponding to each alternative scheduling mode may be calculated based on the first estimated duration for each model training task which uses each model training resource, and the reference indicator corresponding to each alternative scheduling mode is determined based on the second estimated duration.

For any model training task, the iteration process corresponding to any alternative scheduling mode may include a stage in which the model training task uses each model training resource. Referring to FIG. 3B and FIG. 3C, FIG. 3B and FIG. 3C each show an iteration process corresponding to a different scheduling mode.

In an implementation, the second estimated duration of the iteration process corresponding to each alternative scheduling mode may be simulated in a simulation manner. In another implementation, the second estimated duration of the iteration process corresponding to each alternative scheduling mode may also be obtained through calculation. Specifically, for any alternative scheduling mode, the longest duration of using the model training resources in each training stage in an iteration process corresponding to the alternative scheduling mode may be added and summed up, so as to obtain the second estimated duration corresponding to the alternative scheduling mode.

For example, referring to FIG. 3B, in the iteration process of the scheduling mode corresponding to FIG. 3B, in the (n−1)th stage, the duration for the task A which uses the resource 1 is the longest, which is (t2−t1). In the nth stage, the duration for the task B which uses the resource 3 is the longest, which is (t3−t2), and in the (n+1)th stage, the duration for the task C which uses the resource 2 is the longest, which is (t4−t3). Therefore, (t2−t1), (t3−t2), and (t4−t3) are added, and the second estimated duration corresponding to the scheduling mode is (t4−t1).

Because the duration of the iteration process is negatively correlated with the efficiency of use of the model training resources, the efficiency of use of the model training resources corresponding to each alternative scheduling mode may be determined based on the second estimated duration of the iteration process corresponding to each alternative scheduling mode. The efficiency of use of the model training resources corresponding to any alternative scheduling mode may be obtained in the following manner: dividing a sum of the first estimated duration for each model training task which uses each model training resource by the second estimated duration of the iteration process corresponding to the alternative scheduling mode, and then dividing by the number of the model training resources. The efficiency of use of the model training resources corresponding to each alternative scheduling mode may be used as the reference indicator corresponding to the alternative scheduling mode.

For example, referring to FIG. 3B, in the scheduling mode corresponding to FIG. 3B, the second estimated duration of the iteration process is (t4−t1), the number of the model training resources is 3, and the sum of the first estimated duration for each model training task which uses each model training resource is: (t2−t1)+(t2−t1)/2+(t2−t1)/2+(t3−t2)/2+(t3−t2)+(t3−t2)/2+(t4−t3)/2+(t4−t3)/2+(t4−t3)=2(t4−t1). Therefore, the efficiency of use of the model training resources corresponding to the scheduling mode may be calculated as 2/3.

Optionally, the second estimated duration of the iteration process corresponding to each alternative scheduling mode may also be directly used as the reference indicator corresponding to the alternative scheduling mode. Because the duration of the iteration process is negatively correlated with the efficiency of use of the model training resources, a smaller second estimated duration indicates a higher efficiency of use of the model training resources.

In this embodiment, by determining the plurality of alternative scheduling modes, estimating the reference indicator corresponding to each scheduling mode, and selecting the target scheduling mode from the plurality of alternative scheduling modes based on the reference indicator, the task scheduling information is determined. Because the reference indicator is related to the efficiency of use of the model training resources, in this embodiment, the efficiency of use of the model training resources is fully considered when the task scheduling information is determined, and the scheduling mode with the highest efficiency of use of the model training resources is selected to schedule the model training tasks, thereby further improving the utilization of the model training resources and the efficiency of model training.

In addition, the inventors of the present disclosure have found that different processing sequences of the model training tasks may result in different resource usage efficiency in the entire training process, thereby further considering obtaining the plurality of alternative scheduling modes by changing the processing sequences of the model training tasks, and selecting the target scheduling mode with the highest efficiency of use of the model training resources from the plurality of alternative scheduling modes, such that the task scheduling information is determined. Persons skilled in the art have not found the problem. Therefore, the present disclosure also solves the technical problem of low resource usage efficiency in the training process through the discovery of the problem.

It is to be noted that although in the foregoing embodiments, the operations of the method of the embodiments of the present disclosure are described in a specific order, this is not required or implies that these operations must be performed in this specific order, or that all the shown operations must be performed to achieve the desired results. Instead, the steps depicted in the flowcharts may change the order of execution. Additionally or alternatively, some steps may be omitted, multiple steps may be combined into one step for execution, and/or one step may be decomposed into multiple steps for execution.

Corresponding to the foregoing embodiment of the scheduling method for the model training task, the present disclosure further provides an embodiment of a scheduling apparatus for a model training task.

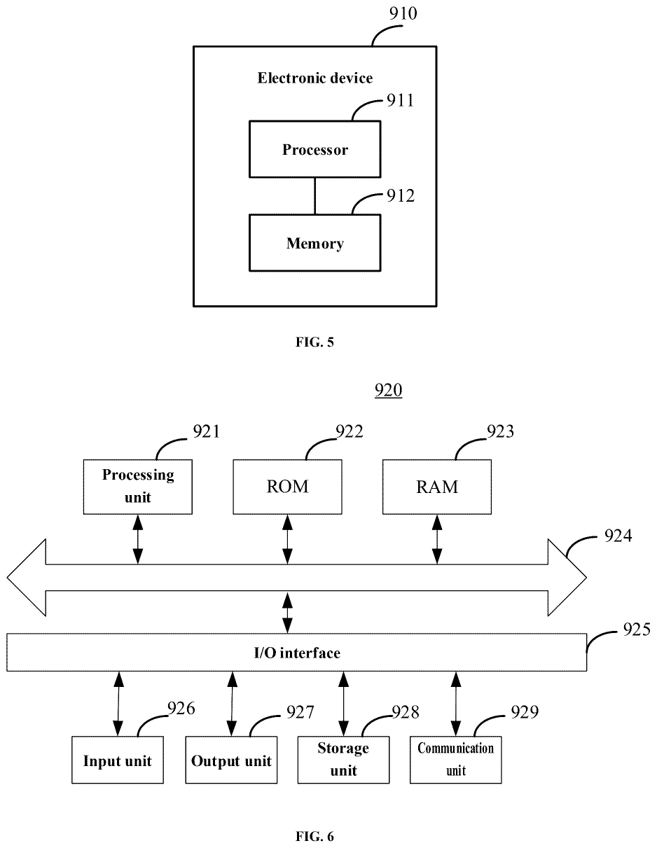

As shown in FIG. 4, FIG. 4 is a block diagram of a scheduling apparatus for a model training task according to an example embodiment of the present disclosure. The apparatus may include an obtaining module 401, a determining module 402, and a scheduling module 403.

The obtaining module 401 is configured to determine a target task group, and the target task group comprises a plurality of model training tasks to be processed.

The determining module 402 is configured to determine task scheduling information, and the task scheduling information comprises a processing sequence of the plurality of model training tasks.

The scheduling module 403 is configured to schedule, based on the task scheduling information, the plurality of model training tasks to use a plurality of model training resources in parallel,, such that different model training tasks use different model training resources at the same time.

In some implementations, the scheduling module 403 is configured to: for a model training resource, schedule the plurality of model training tasks to use the model training resource based on the processing sequence included in the task scheduling information. The plurality of model training tasks are scheduled by training stages, and each model training task is scheduled once in each training stage.

In some other implementations, the determining module 402 may include: an alternative sub-module, an estimation sub-module, and a selection sub-module (not shown in the figure).

The alternative sub-module is configured to determine a plurality of alternative scheduling modes.

The estimation sub-module is configured to estimate a reference indicator corresponding to each scheduling mode, respectively, wherein the reference indicator is associated with the efficiency of use of the model training resources.

The selection sub-module is configured to select a target scheduling mode from the plurality of alternative scheduling modes based on the reference indicator, and determine the task scheduling information based on the target scheduling mode.

In some other implementations, the selection sub-module is configured to select, from the plurality of alternative scheduling modes and based on the reference indicator, a scheduling mode with the highest efficiency of use of the model training resources as the target scheduling mode.

In some other implementations, the estimation sub-module is configured to determine a first estimated duration for each model training task which uses each model training resource. The reference indicator corresponding to each alternative scheduling mode is estimated respectively based on the first estimated duration.

In some other implementations, for any model training resource and any model training task, the estimation sub-module determines the first estimated duration for the model training task which uses the model training resource in the following manner: searching, from pre-stored data, the first estimated duration for the model training task which uses the model training resource. If the first estimated duration for the model training task which uses the model training resource is not found, and calculating the first estimated duration based on the model training resource and the model training task.

In some other implementations, for any alternative scheduling mode, the estimation sub-module estimates the reference indicator corresponding to the alternative scheduling mode in the following manner: calculating a second estimated duration of an iteration process corresponding to the alternative scheduling mode based on the first estimated duration, and determining the reference indicator corresponding to the alternative scheduling mode respectively based on the second estimated duration.

In some other implementations, the number of the model training tasks included in the target task group is less than or equal to the number of the model training resources of different types.

In some other implementations, the plurality of model training tasks are scheduled to the plurality of model training resources of different types by using the same process.

In some other implementations, the plurality of model training resources include a GPU resource, and different model training tasks use the GPU resource through the same context of a compute unified device architecture (CUDA).

For the apparatus embodiments, because they are basically corresponding to the method embodiments, the relevant parts may be referred to the description of the method embodiments. The apparatus embodiments described above are merely illustrative, and the units described as separate parts may or may not be physically separated, and the parts displayed as units may or may not be physical units, and may be located at one place, or may be distributed on a plurality of network units. Some or all of the modules may be selected according to actual needs to achieve the objectives of the solutions of the embodiments of the present disclosure. A person of ordinary skill in the art may understand and implement the embodiments of the present disclosure without creative efforts.

FIG. 5 is a schematic block diagram of an electronic device according to some embodiments of the present disclosure. As shown in FIG. 5, the electronic device 910 includes a processor 911 and a memory 912, and may be configured to implement a client or a server. The memory 912 is configured to non-transitorily store computer-executable instructions (for example, one or more computer program modules). The processor 911 is configured to run the computer-executable instructions, and when the computer-executable instructions are run by the processor 911, one or more steps in the scheduling method for a model training task described above may be performed, thereby implementing the scheduling method for a model training task described above. The memory 912 and the processor 911 may be connected to each other through a bus system and/or another form of connection mechanism (not shown).

For example, the processor 911 may be a central processing unit (CPU), a graphics processing unit (GPU), or another form of processing unit with a data processing capability and/or a program execution capability. For example, the central processing unit (CPU) may be an X86 or ARM architecture. The processor 911 may be a general-purpose processor or a special-purpose processor, and may control other components in the electronic device 910 to perform desired functions.

For example, the memory 912 may include any combination of one or more computer program products, and the computer program products may include various forms of computer-readable storage media, for example, a volatile memory and/or a non-volatile memory. The volatile memory may include, for example, a random-access memory (RAM) and/or a cache. The non-volatile memory may include, for example, a read-only memory (ROM), a hard disk, an erasable programmable read-only memory (EPROM), a portable compact disk read-only memory (CD-ROM), a USB memory, and a flash memory. One or more computer program modules may be stored in the computer-readable storage medium, and the processor 911 may run one or more computer program modules, to implement various functions of the electronic device 910. Various applications, various data, and various data generated and/or used by the applications may also be stored in the computer-readable storage medium.

It should be noted that in the embodiments of the present disclosure, for specific functions and technical effects of the electronic device 910, reference may be made to the description of the scheduling method for a model training task above, which will not be repeated here.

FIG. 6 is a schematic block diagram of another electronic device according to some embodiments of the present disclosure. The electronic device 920 is, for example, suitable for implementing the scheduling method for a model training task provided in the embodiments of the present disclosure. The electronic device 920 may be a terminal device or the like, and may be configured to implement a client or a server. The electronic device 920 may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (for example, a vehicle navigation terminal), and fixed terminals such as a digital TV, a desktop computer, and a smart home device. It should be noted that the electronic device 920 shown in FIG. 6 is merely an example, and shall not impose any limitation on the function and scope of use of the embodiments of the present disclosure.

As shown in FIG. 6, the electronic device 920 may include a processing unit (for example, a central processing unit, a graphics processing unit, or the like) 921, which may perform a variety of appropriate actions and processing in accordance with a program stored in a read-only memory (ROM) 922 or a program loaded from a storage unit 928 into a random-access memory (RAM) 923. The RAM 923 further stores various programs and data required for the operation of the electronic device 920. The processing unit 921, the ROM 922, and the RAM 923 are connected to each other through a bus 924. An input/output (I/O) interface 925 is also connected to the bus 924.

Generally, the following units may be connected to the I/O interface 925: an input unit 926 including, for example, a touch screen, a touchpad, a keyboard, a mouse, a camera, a microphone, an accelerometer, and a gyroscope; an output unit 927 including, for example, a liquid crystal display (LCD), a speaker, and a vibrator; the storage unit 928 including, for example, a tape and a hard disk; and a communication unit 929. The communication unit 929 may allow the electronic device 920 to perform wireless or wired communication with other electronic devices to exchange data. Although FIG. 6 shows the electronic device 920 having various units, it should be understood that it is not required to implement or have all the shown units, and the electronic device 920 may alternatively be implemented to have more or fewer units.

For example, according to an embodiment of the present disclosure, the above scheduling method for a model training task may be implemented as a computer software program. For example, this embodiment of the present disclosure includes a computer program product, which includes a computer program executed on a non-transitory computer-readable medium, wherein the computer program includes program code for performing the scheduling method for a model training task described above. In such an embodiment, the computer program may be downloaded and installed from a network through the communication unit 929, or installed from the storage unit 928, or installed from the ROM 922. When the computer program is executed by the processing unit 921, the function defined in the scheduling method for a model training task provided in the embodiment of the present disclosure may be implemented.

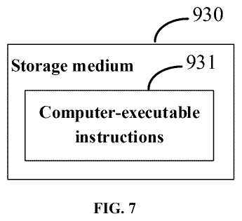

FIG. 7 is a schematic diagram of a storage medium according to some embodiments of the present disclosure. For example, as shown in FIG. 7, a storage medium 930 may be a non-transitory computer-readable storage medium, and is configured to store non-transitory computer-executable instructions 931. When the non-transitory computer-executable instructions 931 are executed by a processor, the scheduling method for a model training task described in the embodiments of the present disclosure may be implemented. For example, when the non-transitory computer-executable instructions 931 are executed by a processor, one or more steps in the scheduling method for a model training task described above may be performed.

For example, the storage medium 930 may be applied to the above electronic device. For example, the storage medium 930 may include a memory in the electronic device. For example, the storage medium may include a memory card of a smartphone, a storage component of a tablet computer, a hard disk of a personal computer, a random-access memory (RAM), a read-only memory (ROM), an erasable programmable read-only memory (EPROM), a portable compact disk read-only memory (CD-ROM), a flash memory, or any combination of the foregoing storage media, or other applicable storage media.

For example, for the description of the storage medium 930, reference may be made to the description of the memory in the embodiment of the electronic device, and repeated parts are not described again. For specific functions and technical effects of the storage medium 930, reference may be made to the description of the scheduling method for a model training task above, which will not be repeated here.

It should be noted that in the context of the present disclosure, the computer-readable medium may be a tangible medium, which may contain or store a program for use by or in combination with an instruction execution system, apparatus, or device. The computer-readable medium may be a computer-readable signal medium, a computer-readable storage medium, or any combination thereof. The computer-readable storage medium may be, for example but not limited to: electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that can be used by or in combination with an instruction execution system, apparatus, or device. In the present disclosure, the computer-readable signal medium may include a data signal propagated in a baseband or as a part of a carrier, where the computer-readable program code is carried. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained on the computer-readable medium may be transmitted by any suitable medium, including but not limited to: electric wires, optical cables, radio frequency (RF), etc., or any suitable combination thereof.

Those skilled in the art will readily conceive of other embodiments of the present disclosure after considering the specification and practicing the invention disclosed herein. The present disclosure is intended to cover any variations, uses, or adaptations of the present disclosure that follow the general principles of the present disclosure and include common knowledge or conventional technical means in the art that is not disclosed in the present disclosure. The specification and examples are only regarded as example, and the true scope and spirit of the present disclosure are indicated by the claims.

It should be understood that the present disclosure is not limited to the precise structures that have been described above and shown in the accompanying drawings, and various modifications and changes may be made without departing from the scope thereof. The scope of the present disclosure is only limited by the appended claims.

1. A model training task scheduling method, comprising:
determining a target task group, the target task group comprising a plurality of model training tasks to be processed;
determining task scheduling information, the task scheduling information comprising a processing sequence of the plurality of model training tasks; and
scheduling, based on the task scheduling information, the plurality of model training tasks to use a plurality of model training resources in parallel such that different model training tasks use different model training resources at the same time.

2. The method according to claim 1, wherein scheduling, based on the task scheduling information, the plurality of model training tasks to use the plurality of model training resources in parallel comprises:
for a model training resource, scheduling the plurality of model training tasks to use the model training resource based on the processing sequence comprised in the task scheduling information, wherein the plurality of model training tasks are scheduled by training stages, and each model training task is scheduled once in each training stage.

3. The method according to claim 1, wherein determining the task scheduling information comprises:
determining a plurality of alternative scheduling modes;
estimating a reference indicator corresponding to each scheduling mode, respectively, the reference indicator being associated with an efficiency of use of the model training resources; and
selecting a target scheduling mode from the plurality of alternative scheduling modes based on the reference indicator, and determining the task scheduling information based on the target scheduling mode.

4. The method according to claim 3, wherein selecting the target scheduling mode from the plurality of alternative scheduling modes based on the reference indicator comprises:
selecting, from the plurality of alternative scheduling modes and based on the reference indicator, a scheduling mode with the highest efficiency of use of the model training resources as the target scheduling mode.

5. The method according to claim 3, wherein estimating the reference indicator corresponding to each scheduling mode, respectively, comprises:
determining a first estimated duration for each model training task which uses each model training resource; and
estimating the reference indicator corresponding to each alternative scheduling mode, respectively, based on the first estimated duration.

6. The method according to claim 5, wherein for a model training resource and a model training task, determining the first estimated duration for each model training task which uses each model training resource comprises:
searching, from pre-stored data, the first estimated duration for the model training task which uses the model training resource; and
in response to determining that the first estimated duration for the model training task which uses the model training resource is found, calculating the first estimated duration based on the model training resource and the model training task.

7. The method according to claim 5, wherein for an alternative scheduling mode, the reference indicator corresponding to each alternative scheduling mode, respectively, is estimated by:
calculating a second estimated duration of an iteration process corresponding to the alternative scheduling mode based on the first estimated duration, and determining the reference indicator corresponding to the alternative scheduling mode based on the second estimated duration.

8. The method according to claim 1, wherein a number of the model training tasks comprised in the target task group is less than or equal to a number of the model training resources of different types.

9. The method according to claim 1, wherein the plurality of model training tasks are scheduled to the plurality of model training resources of different types by using a same process.

10. The method according to claim 1, wherein the plurality of model training resources comprise a GPU resource, and different model training tasks use the GPU resource through a same context of a compute unified device architecture (CUDA).

11. (canceled)

12. A computer-readable storage medium storing instructions thereon, wherein the instructions, when executed by a processor, causes the processor to:
determine a target task group, wherein the target task group comprises a plurality of model training tasks to be processed:
determine task scheduling information, wherein the task scheduling information comprises a processing sequence of the plurality of model training tasks; and
schedule, based on the task scheduling information, the plurality of model training tasks to use a plurality of model training resources in parallel such that different model training tasks use different model training resources at the same time.

13. An electronic device comprising:
a processor;
a memory configured to store one or more instructions,
wherein the one or more instructions, when executed by the processor, cause the processor to:
determine a target task group, wherein the target task group comprises a plurality of model training tasks to be processed;
determine task scheduling information, wherein the task scheduling information comprises a processing sequence of the plurality of model training tasks; and
schedule, based on the task scheduling information, the plurality of model training tasks to use a plurality of model training resources in parallel such that different model training tasks use different model training resources at the same time.

14. The electronic device according to claim 13, wherein the instructions to schedule, based on the task scheduling information, the plurality of model training tasks to use the plurality of model training resources in parallel comprise instructions to:
for a model training resource, schedule the plurality of model training tasks to use the model training resource based on the processing sequence comprised in the task scheduling information, wherein the plurality of model training tasks are scheduled by training stages, and each model training task is scheduled once in each training stage.

15. The electronic device according to claim 13, wherein the instructions to determine the task scheduling information comprises instructions to:
determine a plurality of alternative scheduling modes;
estimate a reference indicator corresponding to each scheduling mode, respectively, wherein the reference indicator is associated with an efficiency of use of the model training resources; and
select a target scheduling mode from the plurality of alternative scheduling modes based on the reference indicator, and determine the task scheduling information based on the target scheduling mode.

16. The electronic device according to claim 15, wherein the instructions to select the target scheduling mode from the plurality of alternative scheduling modes based on the reference indicator comprises instructions to:
select, from the plurality of alternative scheduling modes and based on the reference indicator, a scheduling mode with the highest efficiency of use of the model training resources as the target scheduling mode.

17. The electronic device according to claim 15, wherein the instructions to estimate the reference indicator corresponding to each scheduling mode, respectively, comprises instructions to:
determine a first estimated duration for each model training task which uses each model training resource; and
estimate the reference indicator corresponding to each alternative scheduling mode, respectively, based on the first estimated duration.

18. The electronic device according to claim 17, wherein the instructions to determine, for a model training resource and a model training task, the first estimated duration for each model training task which uses each model training resource comprise instructions to:
search, from pre-stored data, the first estimated duration for the model training task which uses the model training resource; and
in response to determining that the first estimated duration for the model training task which uses the model training resource is found, calculate the first estimated duration based on the model training resource and the model training task.

19. The electronic device according to claim 17, wherein the instructions to estimate, for an alternative scheduling mode, the reference indicator corresponding to each alternative scheduling mode, respectively, comprise instructions to:
calculate a second estimated duration of an iteration process corresponding to the alternative scheduling mode based on the first estimated duration, and determine the reference indicator corresponding to the alternative scheduling mode based on the second estimated duration.

20. The electronic device according to claim 13, wherein at least one of the following:
a number of the model training tasks comprised in the target task group is less than or equal to a number of the model training resources of different types; or
wherein the plurality of model training tasks are scheduled to the plurality of model training resources of different types by using a same process.

21. The electronic device according to claim 13, wherein the plurality of model training resources comprise a GPU resource, and different model training tasks use the GPU resource through a same context of a compute unified device architecture (CUDA).
